(19) United States
(12) Patent Application Publication
(10) Pub. No.: US 2013/0036446 A1
(43) Pub. Date: Feb. 7, 2013

(54) MULTILAYER CONTROLLING SYSTEM OF DATE TRANSFER AND THE METHOD USING THEREOF

(71) Applicants: Chien-Liang CHEN, Taipei City (TW); Huang-Chih Chang, Taipei City (TW)

(72) Inventors: Chien-Liang CHEN, Taipei City (TW); Huang-Chih Chang, Taipei City (TW)

(73) Assignee: GLOBAL VISION SYSTEM CO., LTD., TAIPEI CITY (TW)

(21) Appl. No.: 13/416,208

(22) Filed: Mar. 9, 2012

(30) Foreign Application Priority Data
Aug. 1, 2011 (TW) 100127233

(51) Int. Cl. H04N 21/633

(52) U.S. Cl. 725/116

(57) ABSTRACT

The present invention discloses a multilayer controlling system of data transfer and the method using thereof. The disclosed multilayer controlling system is used for controlling data to transfer from a service operator to pluralities of clients. The system comprises a remote server, at least one intermediate server and pluralities of set-top boxes. The remote server is disposed at the service operator and connects with the intermediate server via a first network interface to take the initiative in transferring the data to the intermediate server. The set-top boxes are disposed at the clients, and the intermediate server connects with the set-top boxes via a second network interface to take the initiative in transferring the date to the set-top boxes. Each of the set-top boxes has a first storage unit, and the data are stored in the first storage unit of each set-top box.

### CROSS-REFERENCE TO RELATED APPLICATIONS

This Non-provisional application claims priority under 35 U.S.C. §119(a) on Patent Application No(s). 100127233 filed in Taiwan, Republic of China, Aug. 1, 2011, the entire contents of which are hereby incorporated by reference.

### FIELD OF THE INVENTION

This invention relates to a multilayer controlling system of data transfer, especially relates to a multilayer controlling system of data transfer and the method using thereof for storing video/audio information in the client beforehand to avoid effecting the quality of the service by the quality of the bandwidth of the service operator.

### BACKGROUND OF THE INVENTION

As the progress of network industry, work, business, shopping and news are capable to combine with the internet communication technique in the modern life. And then, people can always obtain the first hand information all over the world in a short time. Therefore, the internet communication technique has been an essential part of the modern life. At the same time, combining the traditional TV and the network will be the trend of the network application due to the entertainments and knowledge purpose.

As we mentioned before, Internet Protocol Television (IPTV) is the system using the cable to transfer the TV information. According to the definition, IPTV means that the service operator transfers several interactive media service in a video streaming to a terminal device of a client through a protocol of the network. Normally, the terminal device of IPTV can be the electronic devices, such as, computer, TV, cell phone or PDA. However, IPTV will be accomplished by combining with Internet Protocol Set-Top-Box (IP STB) to accept and transfer the signal when the terminal device is traditional TV.

There are two types of the video streaming, such as Broadcast and VOD. VOD is a system of the selective video dominated by the clients, that is, the clients can select the program and control the play mode they want anytime and anywhere. Recently, it is noted by the market because VOD breaks the limit of the traditional TV including time, space and low selectively limit.

According to the abovementioned, VOD is accomplished by streaming. That is, the server will recognize the IP STB and then send the media information to the IP STB immediately after the client makes a request for a certification and permission. The media information will be played through a display by IP STB. When the media information is playing, all the controlling commands issued from the client will be transferred back to the server by IP STB. And then, the server will generate a feedback action corresponding to the controlling commands. However, there are some disadvantages of the abovementioned transmission framework to decrease the pleasure of the client and further limit the development of IPTV.

(1) The server needs to offer an Internet cable to each client. When several clients play at the same time, not only the clients of sharing the bandwidth will be increase, the storage devices used for storing video/audio information and the efficiency of reading and writing are also increase dramatically. According to this situation, the cost of the service operator will increase a lot.

(2) Due to the problem of the efficiency of the server or the quality of the switch, the quality of playing the media through the abovementioned framework will not so well or even interrupt.

(3) As the technology improved, the quality of the media will be higher. The larger bandwidth of the network is necessary to transport the high quality information to IP STB. The video with high resolution will not be transferred on time when the bandwidth of the network is not stable or enough.

### SUMMARY OF THE INVENTION

According to the abovementioned disadvantages of the prior art, the present invention provides a multilayer controlling system of data transfer to store pluralities of video/audio information in clients beforehand. When the client wants to view the above information, they can choose one of them to view directly via a terminal device, and won't be restricted by the quality of the network. In the meantime, the present invention adopts a mechanism of time division and flow classification so that the loading of the service operator will be mitigated and a high resolution Video-On-Demand system with low bandwidth will be achieved.

The first purpose of the present invention is to provide a multilayer controlling system of data transfer for controlling data to transfer from a service operator to pluralities of clients. The system comprises a remote server, at least one intermediate server and pluralities of set-top boxes. The remote server is disposed at the service operator. The intermediate server connects with the remote server via a first network interface, and the remote server will takes the initiative in transferring the data to the intermediate server. The set-top boxes are disposed at the clients, and the intermediate server connects with the set-top boxes via a second network interface to take the initiative in transferring the data to the set-top boxes. Each of the set-top boxes has a first storage unit, and the data are stored in the first storage unit of each set-top box.

Preferably, each of the set-top boxes further comprises a player connected with a terminal device, and the clients can control the player of the set-top boxes to play one of the data they chose via the terminal device. Preferably, the terminal device is a television or a display of an electronic device.

Preferably, the remote server comprises a first initiative data transmission unit for taking the initiative in transferring the data to the intermediate server according to a first bandwidth status of the first network interface.

Preferably, the intermediate server comprises a first data receiving unit and a second storage unit. The first data receiving unit is used for receiving the data transferred from the remote server and checking the accuracy of the data. The second storage unit is used for storing the data.

Preferably, the intermediate server further comprises a second initiative data transmission unit for taking the initiative in transferring the data to the set-top boxes according to a second bandwidth status of the second network interface.

Preferably, the intermediate server provides a check list to the clients according to the data.

Preferably, the first network interface is a wide area network interface and the second network is a local area network interface.

Preferably, the data are pluralities of video/audio information or TV programs.

The second purpose of the present invention is to provide a multilayer controlling method of data transfer for controlling a remote server disposed at a service operator to transfer data to pluralities of set-top boxes of clients via an intermediate server. Each of the set-top boxes has a first storage unit. The method comprising the following steps. The first step is to be executed by the remote server to take the initiative in transferring the data to the intermediate server. And then, the intermediate server receives the data and takes the initiative in transferring the data to the set-top boxes. The data are finally stored into the first storage unit of each set-top box.

Preferably, the remote server is connected with the intermediate server via a first network interface, and the step of the remote server taking the initiative in transferring the data to the intermediate server is performed according to a first bandwidth status of the first network interface.

Preferably, the intermediate server is connected with the set-top boxes via a second network interface, and the step of the intermediate server taking the initiative in transferring the data to the set-top boxes is performed according to a second bandwidth status of the second network interface.

Preferably, the multilayer controlling method further comprises the following steps. First, the client makes a request of a check list to the intermediate server, and then the intermediate server provides the check list according to the request and the data.

Preferably, the multilayer controlling method further comprises the following steps. First, the set-top box receives the check list transferred from the intermediate server, and then the client controls the set-top box dependent upon the check list to selectively view one of the data.

Preferably, the intermediate server has a second storage unit. After the intermediate server receives the data, the multilayer controlling method further comprises the following steps. First, the intermediate server checks whether the data are complete, if yes, the data will be stored into the second storage unit.

Preferably, the multilayer controlling method further comprises the following steps. First, the remote server receives a controlling command of the service operator and transfers the controlling command to the intermediate server. And then, the intermediate server transfers the controlling command to at least one of the set-top boxes. The one of the set-top boxes performs an action according to the controlling command, and the abovementioned action corresponds to the controlling command. Preferably, the action comprises at least a deleting action, a rebooting action, a switching action between several specific interfaces or a transferring action of a designate message.

The features and advantages of the present invention will be understood and illustrated in the following specification and FIGS. 1-3.

### BRIEF DESCRIPTION OF THE DRAWINGS

FIG. 1 is a diagram showing a preferred embodiment of the multilayer controlling system of data transfer according to the present invention;

FIG. 2 is a diagram showing a preferred embodiment of the multilayer controlling system of data transfer according to the present invention; and

FIG. 3 is a diagram showing the flow chart of the multilayer controlling method of data transfer according to the present invention.

### DETAILED DESCRIPTION OF THE INVENTION

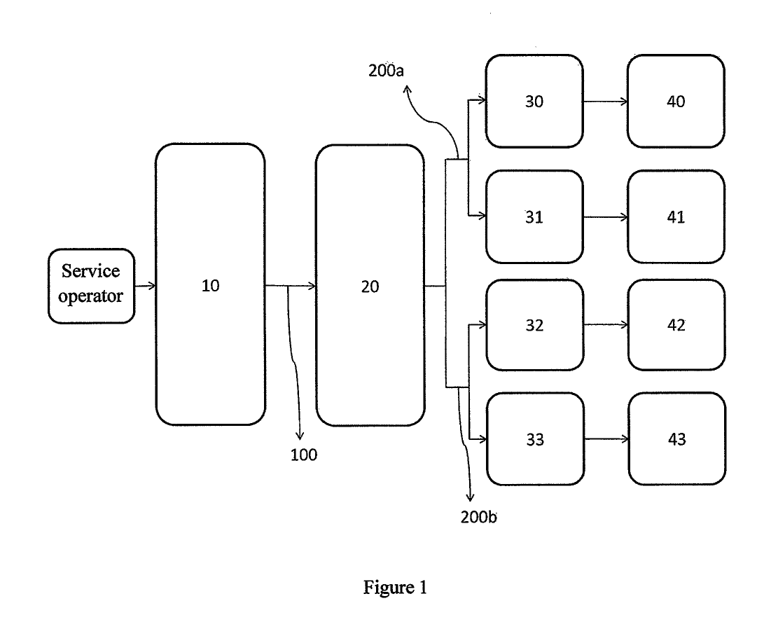

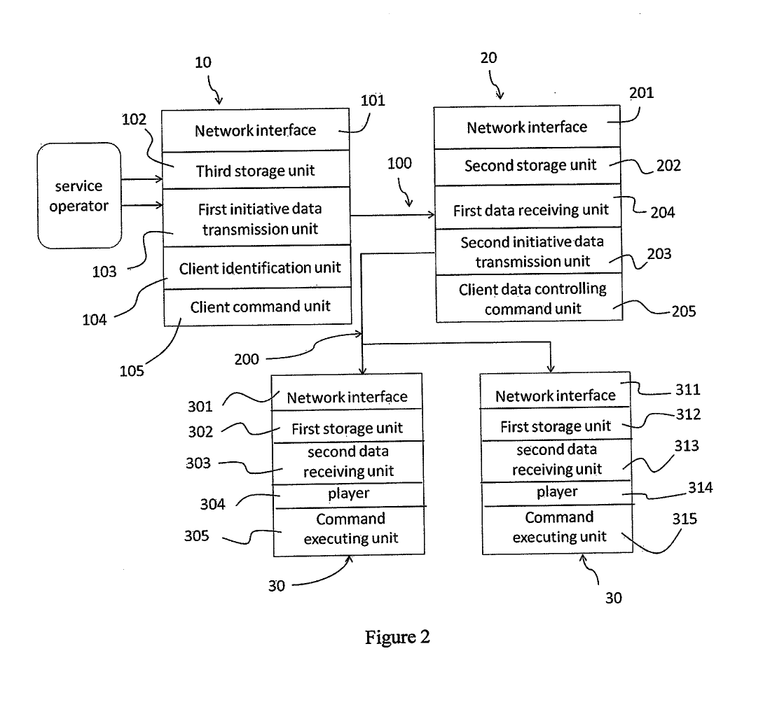

Please refer to FIG. 1 and FIG. 2, FIG. 1 and FIG. 2 are both diagrams showing a preferred embodiment of the multilayer controlling system of data transfer according to the present invention. FIG. 2 is used for further describing the framework of the multilayer controlling system shown in FIG. 1, and some duplicate components will be omitted in FIG. 2.

As shown in FIG. 1, the present invention provides a multilayer controlling system of data transfer for controlling data to transfer from a service operator to pluralities of clients. The system comprises a remote server 10, at least one intermediate server 20 and pluralities of set-top boxes 30, 31, 32, 33. The remote server 10 is disposed at the service operator. The intermediate server 20 connects with the remote server 10 via a first network interface 100, and the remote server 10 will takes the initiative in transferring the data to the intermediate server 20. The set-top boxes 30, 31, 32, 33 are disposed at each of the clients, separately. Preferably, the set-top boxes 30, 31 and the set-top boxes 32, 33 belong to different two local clusters, separately. For example, the set-top boxes 30, 31 belong to two clients lived in a building, and the set-top boxes 32, 33 belong to two departments of a company. And then, the intermediate server 20 can connect with the set-top boxes 30, 31 via a second network interface 200a to take the initiative in transferring the data to the set-top boxes 30, 31. On the other hand, the intermediate server 20 can also connect with the set-top boxes 32, 33 via another second network interface 200b to take the initiative in transferring the data to the set-top boxes 32, 33.

Preferably, the set-top boxes 30, 31 further comprise players 304, 314 and connect with terminal devices 40, 41, separately, as shown in FIG. 1. The clients, who own the set-top boxes 30, 31, can control the players 304, 314 of the set-top boxes 30, 31 to play one of the data chose by the clients via terminal devices 40, 41. That is, when the data comprise pluralities of TV programs, the clients can choose which program they want to watch by controlling the player of the set-top box, and the programs can be played via the terminal devices. In the preferred embodiment, the terminal device 40 can be a television or a display of an electronic device. However, the present invention will not be limited thereto.

Please refer to FIG. 2. The remote server 10 comprises a first initiative data transmission unit 103 for taking the initiative in transferring the data to the intermediate server 20 according to a first bandwidth status of the first network interface 100. That is, the remote server 10 will take the initiative in transferring data to the intermediate server 20 while the quality of the first network interface 100 is good, such as good bandwidth. On the contrary, the remote server 10 will stop transferring data or transfer less data to the intermediate server 20 while the quality of the first network interface 100 is not good. In the meantime, the data provided by the service operator can be stored in a third storage unit 102 of the remote server 10. The date storage in the remote server 10 will be then transferred while the quality of the first network interface 100 is stable. The abovementioned mechanism of time division and flow classification will further mitigate the loading of the remote server 10.

The intermediate server 20 comprises a second storage unit 202 and a first data receiving unit 204. The first data receiving unit 204 is used for receiving the data transferred from the remote server 10 and checking the accuracy of the data, and the second storage unit 204 is used for storing the data. Besides, the intermediate server 20 further comprises a second initiative data transmission unit 203 for taking the initiative in transferring the data to the set-top boxes 30, 31 according to a second bandwidth status of the second network interface 200. As the abovementioned, the intermediate server 20 will take the initiative in transferring data to the set-top boxes 30, 31 while the quality of the second network interface 200 is good. On the contrary, the intermediate server 20 will stop transferring data or transfer less data to the set-top boxes 30, 31 while the quality of the second network interface 200 is not good. In the meantime, the data transferred from the remote server 10 can be stored in the second storage unit 202. The date storage in the intermediate server 20 will be then transferred to the set-top boxes 30, 31 while the quality of the second network interface 200 becomes stable.

Please refer to FIG. 2. The remote server 10 further comprises a client identification unit 104. Basically, the setting of single client or whole clients can be performed on the remote server 10 by the service operator. For example, the contents of video/audio information, which can be played at the client A or the clients of a certain local cluster, will be set on the remote server 10. And then, the remote server 10 determines where the data are transferred to via the client identification unit 104, and transfers the data and the setting of the service operator to the intermediate server 20. The data and the setting will be stored in the second storage unit 202 of the intermediate server 20.

The set-top boxes 30, 31 comprise second data receiving units 303, 313 separately which are used for receiving the data transferred from the second initiative data transmission unit 203 of the intermediate server 20. And further, each of the set-top boxes 30, 31, 32, 33 has a first storage unit 302, 312 (the details of the set-top boxes 32, 33 has been omitted in FIG. 2). The data can be stored into the first storage unit 302 of the set-top box 30 and the first storage unit 312 of the set-top box 31 after the second data receiving units 303, 313 check the accuracy of the data. And then, identification information of the data will be transferred back to the intermediate server 20 to complete the process of data transfer.

If the client wants to check how many information, such as movies, stored in the set-top box, he or she can make a request of a check list to the intermediate server 20. After receiving the request, the intermediate server 20 will reply the check list to the set-top box of the client. It is noted that the abovementioned check list corresponds to the contents of the set-top box which the client owns. After the client receives the check list, the client can make a choice according to the check list and the player of the set-top box will play the chosen movie directly from its storage unit. That is, the playing procedure of the movie for the client does not need to connect with the intermediate server 20 so that the quality of the playing procedure is not dependent upon the quality of the network.

Besides the abovementioned process of data transfer, the service operator can further perform different operation control through the multilayer controlling system disclosed in the present invention. The details will be illustrated in the following specification.

Please refer to FIG. 2 again. The remote server 10 further comprises a client command unit 105, and the intermediate server 20 further comprises a client data controlling unit 205. Furthermore, the set-top boxes 30, 31 comprise command executing units 305, 315, separately. When the service operator wants to make a controlling command, such as a command of deleting the movie, to the set-top box of a specific client (using the set-top box 30 as an example), the client command unit 105 of the remote server 10 will search for the intermediate server 20 which the specific client belongs to and transfer the controlling command to the intermediate server 20. After receiving the controlling command, the intermediate server 20 will issue the controlling command to the set-top box 30 through the client data controlling unit 205. In the meantime, the command executing unit 305 of the set-top box 30 will execute a corresponding action according to the controlling command, that is to say, the movie stored in the second storage unit 302 will be deleted. After deleting, the set-top box 30 will transfer identification information of the deleted movie back to the intermediate server 20. Preferably, the controlling command can be a rebooting command, a switching command of a specific interface or a command for transferring a designate message. Simply speaking, the controlling command is always transferred through the abovementioned three layer controlling system. That is, the controlling command is transferred from the remote server to the intermediate server, and the intermediate server then transfers the controlling command to the set-top box of the client. The set-top box of the client performs a corresponding action according to the controlling command.

Preferably, the data are pluralities of video/audio information or TV programs. Besides, the first network interface is a wide area network interface and the second network is a local area network interface, such as a wireless local area network, a Bluetooth local area network, an infrared local area network and an Ethernet.

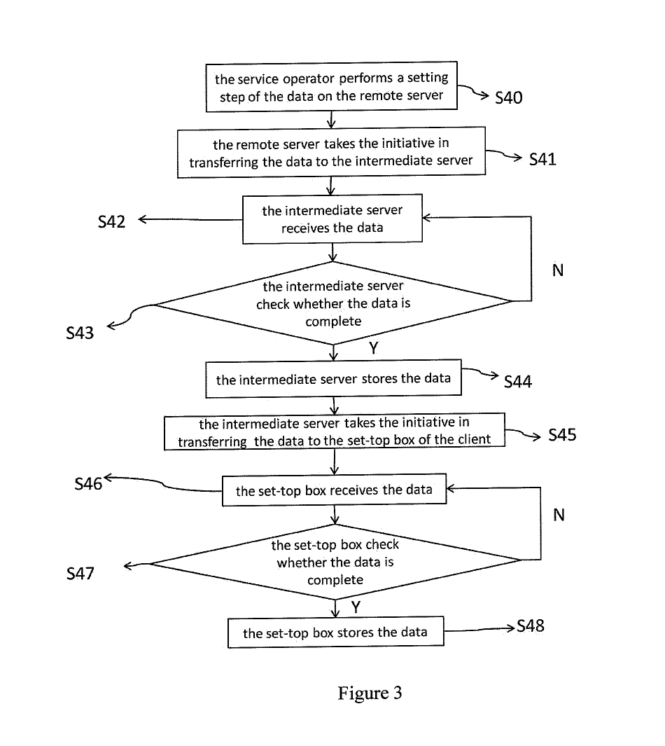

The multilayer controlling system disclosed in the present invention has illustrated as abovementioned, and a multilayer controlling method will be disclosed in the following. Please refer to FIG. 3, FIG. 3 is a diagram showing the flow chart of the multilayer controlling method of data transfer according to the present invention. First, the service operator performs a setting step of the data on the remote server S40. And then, the remote server takes the initiative in transferring the data to the intermediate server according to a bandwidth status of the first network interface S41. After the intermediate server receives the data S42, the intermediate server checks whether the data is complete S43, if not, it means that the remote server still transfers the data to the intermediate server. The steps S42, S43 will be repeated at that time for checking the accuracy of the data. If the data are received completely by the intermediate server, the intermediate server will store the data S44. And then, the intermediate server takes the initiative in transferring the data to the set-top box of each client S45 according to a bandwidth status of the second network interface. After receiving the data S46, the set-top box will check the accuracy of the data S47. When the set-top box determines the data are completely received, the data are stored into a storage unit of the set-top box S48.

Preferably, the multilayer controlling method further comprises the following steps. First, the client makes a request of a check list to the intermediate server, and then the intermediate server provides the check list according to the request and the data. After the set-top box receives the check list transferred from the intermediate server, the client controls the set-top box dependent upon the check list to selectively view one of the data.

As the abovementioned, the service operator can further control the data of the set-top box through the multilayer controlling method disclosed in the present invention. Therefore, the present method further comprises the following steps. First, the remote server receives a controlling command of the service operator and transfers the controlling command to the intermediate server. And then, the intermediate server transfers the controlling command to at least one of the set-top boxes. The one of the set-top boxes performs an action according to the controlling command, and the abovementioned action corresponds to the controlling command. Preferably, the action comprises at least a deleting action, a rebooting action, a switching action between several specific interfaces or a transferring action of a designate message.

According to the multilayer controlling system disclosed in the present invention, the video is stored at the set-top box of the client when the client plays the video. That is, the playing procedure of the video does not need to be dependent upon the quality of the network and the loading of the service operator. Therefore, the disadvantages, such as the transmitting speed and the stability of the network, the input/output of the server and the operation ability, won't effect the quality of playing the video according to the present invention. Furthermore, the service operator can control the transmitting speed and quantity of the data according to the efficiency of the system so that the cost will be decreased. Simply speaking, the advantages of the present invention are illustrated as follows.

(1) According to the property of the clusters and the combination of the wide area network and the local area network, it is easily to achieve the purpose of saving the bandwidth and fees. The unlimited quantity of the clients can be further achieved through the abovementioned framework.

(2) The present invention provides an integrated playing and controlling system to the set-top box with a storage unit. The data will be transferred to each set-top box beforehand; and further, the client plays the stored data. That is, the data can be performed on the set-top box without the network so that some unusual condition resulted from the server and the quality of the network will be eliminated. Therefore, then present invention can be applied for the client, such as hotel, school, hospital and family, for playing a high resolution video.

(3) The video is completely received and stored by the set-top box when the client plays, therefore, the video can be played repeatedly and controlled, such as forward, reverse and stop regardless of the bandwidth.

(4) The service operator can issue different operation commands to each client via a central site for easily controlling and decreasing the risk of the operation. Moreover, the staff of the service operator can control each client via a mobile communication device with the network. That is, the operation controlling of the service operator won't be restricted by space.

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims.

What is claimed is:

1. A multilayer controlling system of data transfer for controlling data to transfer from a service operator to pluralities of clients, the system comprises:
a remote server disposing at the service operator;
at least one intermediate server connecting with the remote server via a first network interface, and the remote server taking the initiative in transferring the data to the intermediate server; and
pluralities of set-top boxes disposing at the clients, and the intermediate server connecting with the set-top boxes via a second network interface to take the initiative in transferring the data to the set-top boxes,
wherein each of the set-top boxes having a first storage unit, and the data being stored in the first storage unit of each set-top box.

2. The multilayer controlling system according to claim 1, wherein each of the set-top boxes further comprises a player connected with a terminal device, and the clients can control the player of the set-top boxes to play one of the data they chose via the terminal device.

3. The multilayer controlling system according to claim 2, wherein the terminal device is a television or a display of an electronic device.

4. The multilayer controlling system according to claim 1, wherein the remote server comprises a first initiative data transmission unit for taking the initiative in transferring the data to the intermediate server according to a first bandwidth status of the first network interface.

5. The multilayer controlling system according to claim 1, wherein the intermediate server comprises a first data receiving unit and a second storage unit, the first data receiving unit is used for receiving the data transferred from the remote server and checking the accuracy of the data, and the second storage unit is used for storing the data.

6. The multilayer controlling system according to claim 5, wherein the intermediate server further comprises a second initiative data transmission unit for taking the initiative in transferring the data to the set-top boxes according to a second bandwidth status of the second network interface.

7. The multilayer controlling system according to claim 1, wherein the intermediate server provides a check list to the clients according to the data.

8. The multilayer controlling system according to claim 1, wherein the first network interface is a wide area network interface and the second network is a local area network interface.

9. The multilayer controlling system according to claim 1, wherein the data are pluralities of video/audio information or TV programs.

10. A multilayer controlling method of data transfer for controlling a remote server disposed at a service operator to transfer data to pluralities of set-top boxes of clients via an intermediate server, wherein each of the set-top boxes has a first storage unit, the method comprising the following steps:
the remote server taking the initiative in transferring the data to the intermediate server;
the intermediate server receiving the data;
the intermediate server taking the initiative in transferring the data to the set-top boxes; and
storing the data into the first storage unit of each set-top box.

11. The multilayer controlling method according to claim 10, wherein the remote server is connected with the intermediate server via a first network interface, and the step of the remote server taking the initiative in transferring the data to the intermediate server is performed according to a first bandwidth status of the first network interface.

12. The multilayer controlling method according to claim 10, wherein the intermediate server is connected with the set-top boxes via a second network interface, and the step of the intermediate server taking the initiative in transferring the data to the set-top boxes is performed according to a second bandwidth status of the second network interface.

13. The multilayer controlling method according to claim 10, further comprising the following steps:
the client making a request of a check list to the intermediate server; and
the intermediate server providing the check list according to the request and the data.

14. The multilayer controlling method according to claim 13, further comprising the following steps:
the set-top box receiving the check list transferred from the intermediate server; and
the client controlling the set-top box dependent upon the check list to selectively view one of the data.

15. The multilayer controlling method according to claim 10, wherein the intermediate server having a second storage unit and further comprising the following steps after the intermediate server receiving the data:
the intermediate server checking whether the data are complete, if yes, storing the data into the second storage unit, if no, continuing receiving the data.

16. The multilayer controlling method according to claim 10, further comprising the following steps:
the remote server receiving a controlling command of the service operator;
the remote server transferring the controlling command to the intermediate server;
the intermediate server transferring the controlling command to at least one of the set-top boxes; and
the one of the set-top boxes performing an action according to the controlling command, wherein the action corresponding to the controlling command.

17. The multilayer controlling method according to claim 16, wherein the action comprising at least a deleting action, a rebooting action, a switching action between several specific interfaces or a transferring action of a designate message.
